(19) United States
(12) Patent Application Publication
(10) Pub. No.: US 2014/0213308 A1
(43) Pub. Date: Jul. 31, 2014

(54) Atmospheric Pressure Sensor

(71) Applicant: TRANSDUCERS DIRECT LLC, Cincinnati, OH (US)

(72) Inventors: Robert W Matthes, Loveland, OH (US); David A Topmiller, Edgewood, KY (US)

(73) Assignee: TRANSDUCERS DIRECT LLC, Cincinnati, OH (US)

(21) Appl. No.: 13/755,271

(22) Filed: Jan. 31, 2013

(51) Int. Cl. G08B 21/02

(52) U.S. Cl. CPC G08B 21/02
USPC 455/466; 340/601; 340/539.26

(57) ABSTRACT

An atmospheric pressure sensor is disclosed which comprises an atmospheric pressure sensing element, a processing unit, and an interface unit. The atmospheric pressure sensing element is operable to measure the atmospheric pressure, and the processing unit is electrically coupled to the atmospheric pressure sensing element and is operable to read the measured atmospheric pressure from the atmospheric pressure sensing element. The processing unit is operable to generate a message if the measured atmospheric pressure meets one or more criteria. And the interface unit is electrically coupled to the processing unit and is operable to electrically receive the message from the processing unit and transmit the message to a receiving device.

### TECHNICAL FIELD

The present disclosure generally relates to atmospheric pressure sensors and, in particular, to atmospheric pressure sensors capable of transmitting a message if the measured atmospheric pressure meets one or more criteria.

### BACKGROUND

As background, atmospheric pressure sensors are transducers which are capable of measuring the pressure of the earth's atmosphere. The actual atmospheric pressure at any particular location on earth may depend on a number of factors such as the altitude, the temperature, and the type of weather at that location. Relatively quick changes in the atmospheric pressure may indicate that the weather could change within the next few hours. For example, a relatively quick decrease in the atmospheric pressure may indicate that inclement weather may be approaching.

There may be a benefit to having the atmospheric pressure sensor automatically notify a person of relatively quick changes in the atmospheric pressure. People who are vulnerable to weather conditions, such as someone piloting a boat at sea, may like to be informed as soon as possible of such changes in the atmospheric pressure so that they can check the weather report and/or take precautions against the possibility of the weather changing. Such notifications may obviate the need for the person to constantly monitor the atmospheric pressure sensor. There may also be a benefit if the person is away from the atmospheric pressure sensor, and the notification is performed via the person's smartphone or other portable electronic device. For example, the person may be notified via a wireless message sent to the person's iPhone®.

The embodiments of an atmospheric pressure sensor shown and described herein may be capable of measuring the atmospheric pressure and transmitting a message if the measured atmospheric pressure meets one or more criteria.

### SUMMARY

An atmospheric pressure sensor is disclosed, the atmospheric pressure sensor comprising an atmospheric pressure sensing element, a processing unit, and an interface unit, wherein: the atmospheric pressure sensing element is operable to measure the atmospheric pressure; the processing unit is electrically coupled to the atmospheric pressure sensing element and is operable to read the measured atmospheric pressure from the atmospheric pressure sensing element; the processing unit is operable to generate a message if the measured atmospheric pressure meets one or more criteria; and the interface unit is electrically coupled to the processing unit and is operable to electrically receive the message from the processing unit and transmit the message to a receiving device.

A method is disclosed for transmitting a message from an atmospheric pressure sensor, wherein: the atmospheric pressure sensor comprises an atmospheric pressure sensing element, a processing unit, and an interface unit; the atmospheric pressure sensing element is electrically coupled to the processing unit; and the interface unit is electrically coupled to the processing unit, and the method comprises: measuring the atmospheric pressure by the atmospheric pressure sensing element; reading the measured atmospheric pressure by the processing unit from the atmospheric pressure sensing element; generating a message by the processing unit if the measured atmospheric pressure meets one or more criteria; sending the message by the processing unit to the interface unit; and transmitting the message by the interface unit to a receiving device

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference characters and in which:

FIG. 1 depicts an atmospheric pressure sensor according to one or more embodiments shown and described herein;

FIG. 2. shows a processing unit according to one or more embodiments shown and described herein;

FIGS. 3A-D illustrate interface units according to one or more embodiments shown and described herein;

FIGS. 4A-B depict atmospheric pressure criteria according to one or more embodiments shown and described herein; and

FIG. 5 shows a receiving device according to one or more embodiments shown and described herein.

### DETAILED DESCRIPTION

This disclosure generally relates to atmospheric pressure sensors which are capable of transmitting a message to a receiving device if the measured atmospheric pressure meets one or more criteria. In one embodiment, a criterion may comprise whether the measured atmospheric pressure rises above or falls below a pressure setpoint. In another embodiment, a criterion may comprise whether the measured change in atmospheric pressure with respect to time exceeds a pressure rate setpoint. Such criteria may indicate that the weather may change in the near future, and the transmitted message may inform a user of the receiving device to take appropriate or necessary actions.

The atmospheric pressure is typically measured with respect to a perfect vacuum and may be measured in any suitable units of measurement including millimeters of mercury (mmHg), inches of mercury (inHg), pounds per square inch (psi), bar, millibar, and Pascals. For the purposes of this disclosure, inches of mercury (inHg) will primarily be used, although it is to be understood that other units of measurement may be used as well. The atmospheric pressure on earth typically can vary from about 27 inHg to about 32 inHg and can be affected by altitude, temperature, weather, and other factors. If an atmospheric pressure sensor remains at approximately the same altitude or in approximately the same location, the value of the atmospheric pressure and/or changes in the atmospheric pressure may indicate that the weather could be about change.

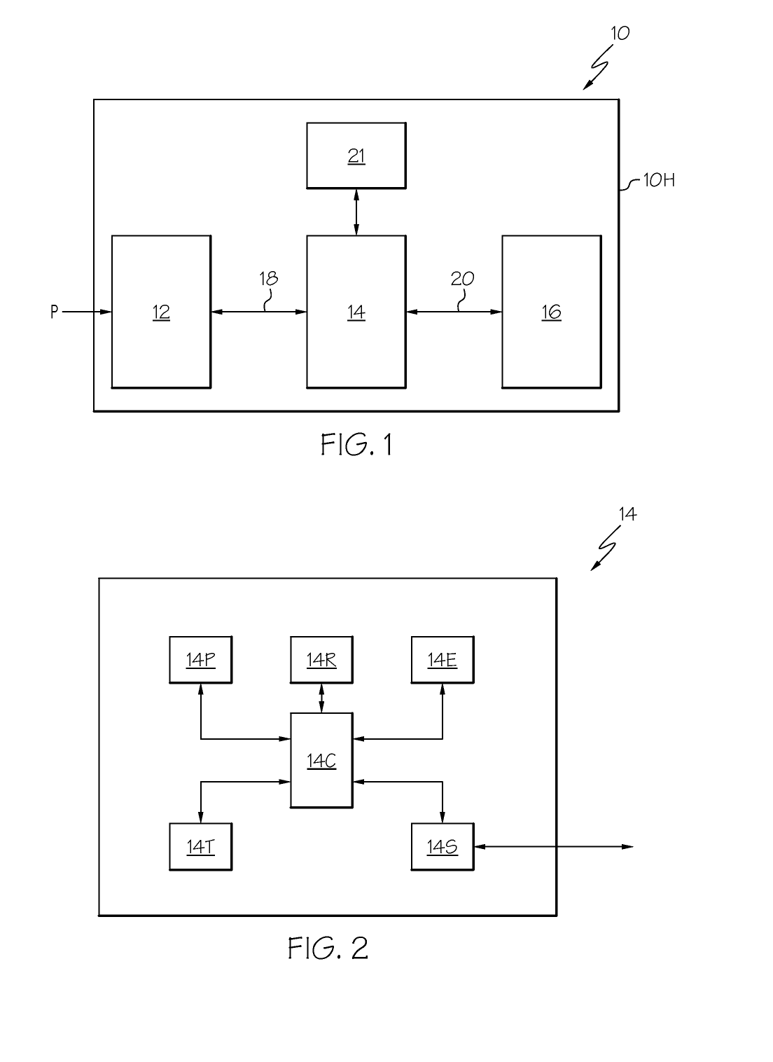

FIG. 1 depicts an atmospheric pressure sensor 10 according to one embodiment. The atmospheric pressure sensor 10 may comprise an atmospheric pressure sensing element 12, a processing unit 14, and an interface unit 16. The atmospheric pressure sensing element 12 may be electrically coupled to the processing unit 14 via a first interface 18. Likewise, the processing unit 14 may be electrically coupled to the interface unit 16 via a second interface 20. The processing unit 14 may be capable of periodically reading the measured atmospheric pressure from the atmospheric pressure sensing element 12 via the first interface 18. Upon reading the measured atmospheric pressure one or more times, the processing unit 14 may be capable of determining whether the measured atmospheric pressure meets one or more criteria. The criteria may comprise, for example, whether the measured atmospheric pressure rises above or falls below a pressure setpoint. As another example, the criteria may comprise whether the change in atmospheric pressure with respect to time exceeds a pressure rate setpoint. The criteria may also include combinations of one or more pressure setpoints and/or one or more pressure rate setpoints.

The processing unit 14 may be capable of generating a message if the measured atmospheric pressure meets the one or more criteria. As such, the processing unit 14 may be capable of sending the message to the interface unit 16 via the second interface 20. The interface unit 16 may be capable of receiving the message from the processing unit 14 and transmitting the message to a receiving device (not shown). The atmospheric pressure sensor 10 may be disposed in a housing 10H to protect its components and to make handling easier. The housing 10H may be constructed of metal, plastic, or any other suitable material.

The atmospheric pressure sensor 10 may also comprise other electrical and/or mechanical components (not shown) which facilitate its operation. For example, it may also comprise one or more electrical connectors which may provide electrical power to it and/or provide a means for the interface unit 16 to transmit the message to a receiving device. Moreover, the atmospheric pressure sensor 10 may comprise a voltage regulator (not shown) in order to provide a stable power supply for the atmospheric pressure sensing element 12, processing unit 14, and interface unit 16. The electrical components comprising the atmospheric pressure sensor 10 may be affixed to one or more printed circuit boards. Other electrical and/or mechanical components may be included, as is known in the art.

The atmospheric pressure sensing element 12 may comprise an electronic device that is capable of measuring the atmospheric pressure. For example, the LPS331AP device from ST Microelectronics (Geneva, Switzerland; www.st.com) is a single-chip sensor which uses a monolithic sensing element and an integrated circuit to provide a digital output signal corresponding to the measured atmospheric pressure. The LPS331AP can be configured to operate with either an SPI (serial peripheral interface) or an I²C (inter-integrated circuit) interface. Thus, the first interface 18 may comprise either an SPI or I²C interface, and the processing unit 14 may read the measured atmospheric pressure from the LPS331AP via this interface. The update rate of the LPS331AP is programmable from 1 Hz to 25 Hz, and the LPS331AP periodically samples the atmospheric pressure at this rate. The atmospheric pressure is converted by the LPS331AP into a digital number representing the measured atmospheric pressure in millibar such that the processing unit 14 reads this digital number as the measured atmospheric pressure. The LPS331AP may be calibrated at the factory so that it has an absolute accuracy of about ±2.6 millibar. The processing unit 14 may convert the measured atmospheric pressure from millibar to inHg or any other suitable unit of measurement.

As another example, the atmospheric pressure sensing element 12 may comprise the MS5607-02BA03 device from Measurement Specialties, Inc. (Hampton, Va.; www.meas-spec.com). The MS5607-02BA03 device is based on MEMS (micro-electromechanical systems) and may also be configured to operate with either an SPI or I²C interface. Other types of devices may be used as well, as is known in the art. Furthermore, it is contemplated that the atmospheric pressure sensing element 12 may be constructed of discrete components such as transistors, resistors, capacitors, and so forth. The atmospheric pressure sensing element 12 may be disposed within the pressure sensor housing 10H such that the atmospheric pressure sensing element 12 is exposed to the ambient atmospheric pressure P. Accordingly, the housing 10H may have a vent hole or other suitable means to permit the atmospheric pressure sensing element 12 to have access to the atmospheric pressure P.

The processing unit 14 may periodically read the measured atmospheric pressure from the atmospheric pressure sensing element 12 at periodic intervals, hereinafter called the “update rate.” For example, the processing unit 14 may read the atmospheric pressure sensing element 12 every one second, every ten seconds, every thirty seconds, every one minute, or at any suitable update rate. As such, the processing unit 14 may acquire and store past samples of the measured atmospheric pressure in order to determine the rate of change of the atmospheric pressure. In addition, the processing unit 14 may change the update rate, based on whether and/or how quickly the measured atmospheric pressure is changing. If the atmospheric pressure is not changing or changing very slowly, the processing unit 14 may set the update rate to a relatively long time period in order, for example, to conserve battery life. Similarly, the processing unit 14 may set the update rate to a relatively short time period if it determines that the atmospheric pressure is changing quickly, which may allow the processing unit 14 to determine the rate of change more accurately. Thus, the processing unit 14 may adaptively change the update rate based on the present atmospheric pressure conditions. The processing unit 14 may also read the measured atmospheric pressure from the atmospheric pressure sensing element 12 at aperiodic intervals as well.

As discussed above, the atmospheric pressure sensing element 12 may be programmed to internally measure the atmospheric pressure at sampling rates of, for example, 1 Hz to 25 Hz. The update rate of the processing unit 14 may be configured to be the same as the sampling rate of the atmospheric pressure sensing element 12. Alternatively, the update rate of the processing unit 14 may be configured to be slower than the sampling rate of the atmospheric pressure sensing element 12. In this embodiment, the processing unit 14 may read the measured atmospheric pressure from the atmospheric pressure sensing element 12 at the slower update rate.

The atmospheric pressure sensor 10 may further comprise a display 21 which may permit visual information, such as text or graphics, to be available to the user. Such visual information may include the current measured atmospheric pressure, a graph of the measured atmospheric pressure over time, or an alert which indicates that the measured atmospheric pressure has met the one or more criteria. The display 21 may be a liquid crystal display (LCD), light emitting diodes (LED), or any other suitable technology. The display 21 may be electrically coupled to the processing unit 14 such that the processing unit 14 is operable to determine what information is shown on the display 21. The atmospheric pressure sensor 10 may also comprise an audible alarm (not shown) in order to notify the user that the measured atmospheric pressure has met the one or more criteria.

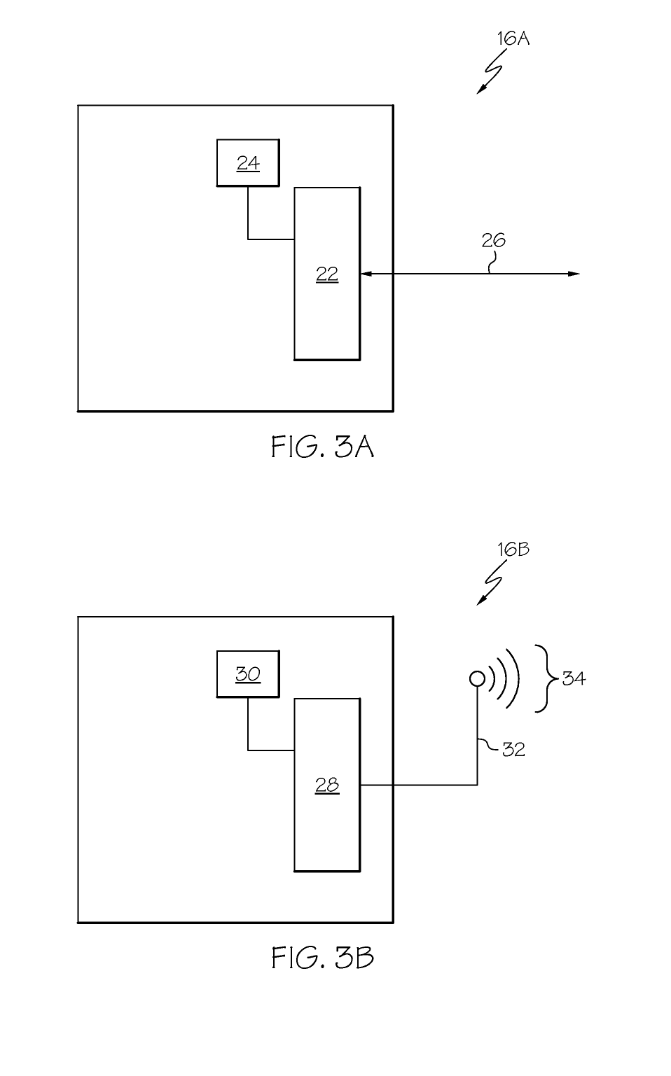

Referring now to FIG. 2, the processing unit 14 may comprise a CPU (central processing unit) 14C, program memory 14P, RAM (random access memory) 14R, EEPROM (electrically-erasable programmable read-only memory) 14E, one or more timers 14T, an SPI interface 14S, and other such peripherals which facilitate the operation of the microcontroller. The program memory 14P may store machine readable instructions for the CPU 14C which, when executed, may define the operation of the atmospheric pressure sensor 10. The computer program may be written by a programmer in the “C” programming language, assembly language, or any other suitable computer programming language. The computer program may be compiled into machine readable instruction and subsequently stored in the program memory 14P. The RAM 14R may store variables during the execution of the program instructions. For example, the RAM may store one or more past samples of the measured atmospheric pressure. The EEPROM 14E may store information which defines the one or more criteria which determine whether the processing unit 14 sends a message to the interface unit.

The one or more timers 14T may facilitate the operation of the processing unit 14 by permitting certain events to occur at relatively precise intervals. As an example, one timer 14T may set the update rate for the atmospheric pressure measurement. The SPI interface 14S may allow the processing unit 14 to read data from and write data to other electronic devices, such as the atmospheric pressure sensing element 12 and/or the interface unit 16. In one embodiment, the same SPI interface 14S may be used to interface to both the atmospheric pressure sensing element 12 and the interface unit 16. The processing unit 14 may comprise other peripherals, as is known in the art, in order to facilitate its operation such as, but not limited to, an oscillator, a reset circuit, and general purpose input/output pins.

In one embodiment, the processing unit 14 may comprise a PIC24F16KA101 microcontroller from Microchip Technology (Chandler, Ariz.; www.microchip.com). The PIC24F16KA101 comprises all the peripherals shown in FIG. 2, including a CPU 14C, program memory 14P, RAM 14R, EEPROM 14E, one or more timers 14T, and an SPI interface 14S. The PIC24F16KA101 also comprises a reset circuit, an oscillator, a UART (universal asynchronous receiver/transmitter), and a 10-bit A-to-D (analog-to-digital) converter. Other types of microcontrollers and microprocessors may be used as well, as is known in the art.

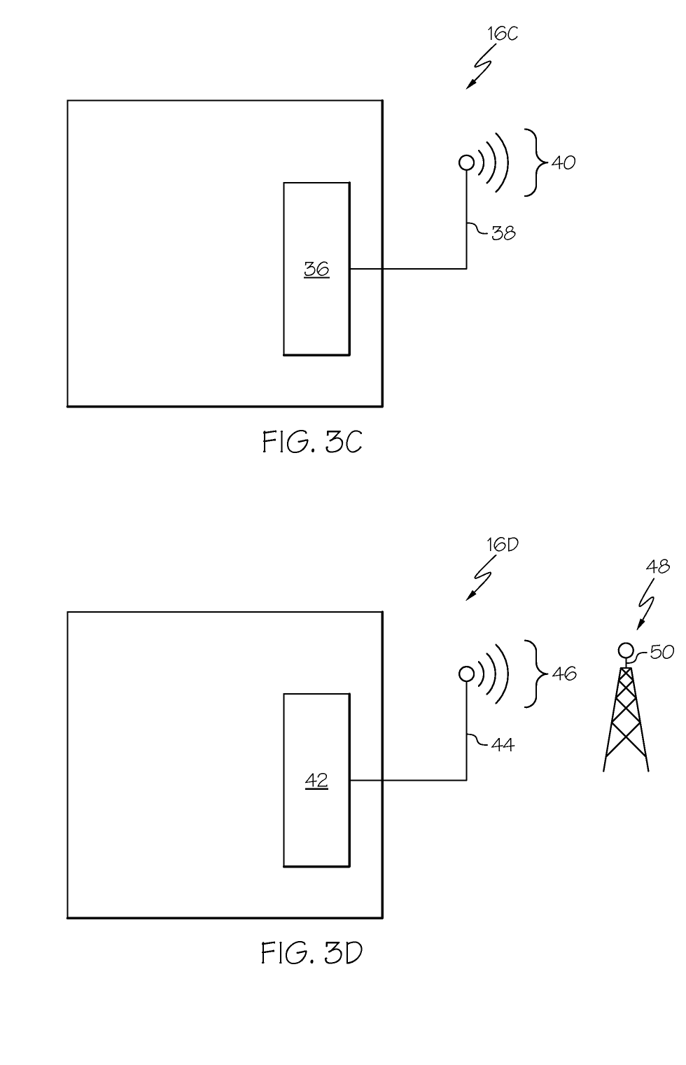

Referring now to FIGS. 3A-D, exemplary interface units are shown. In FIG. 3A, the interface unit 16A comprises an Ethernet interface 22. Such an interface may conform to the IEEE 802.3 standard promulgated by the Institute of Electrical and Electronic Engineers. The processing unit may be electrically coupled to the interface unit 16A such that the processing unit is operable to send and receive message via Ethernet interface 22. The messages may be physically transported via an Ethernet cable 26 which may be electrically coupled to the Ethernet interface 22. The Ethernet cable 26 may comprise a Cat-5 cable or similar cable. The interface unit 16A may further comprise an IP (Internet Protocol) address 24, which may facilitate the sending and receiving of messages via the Ethernet interface 22 to any other IP-enabled device via TCP/IP protocol. Other communications protocols may be used as well.

In one embodiment, the Ethernet cable 26 is electrically coupled to an external device (e.g., a router or access point) with access to the internet. This external device may be connected to the internet via a wired or a wireless means. Accordingly, the interface unit 16A may be capable of sending messages to and receiving messages from a smartphone (e.g., an iPhone®, Android®, or Windows® phone) which also has access to the internet (e.g., via the smartphone's cellular network). The interface unit 16A may send a message to the smartphone, for example, when the measured atmospheric pressure has met the one or more criteria. In this scenario, the user of the smartphone may be miles away from the atmospheric pressure sensor and still receive messages from the atmospheric pressure sensor. The message may comprise a text message which may be transmitted to a smartphone using SMS (Short Message Service), email, or any other suitable text messaging service. In addition, the text message may have embedded graphics and/or video.

FIG. 3B shows yet another embodiment of the interface unit 16B. In this embodiment, the interface unit 16B comprises a Wi-Fi interface 28. The processing unit may be electrically coupled to the Wi-Fi interface 28 such that the processing unit is capable of sending and/or receiving wireless messages 34 via the Wi-Fi interface 28. The Wi-Fi interface 28 may comprise an antenna 32 in order to facilitate the transmission and/or reception of wireless messages 34. The Wi-Fi interface 28 may conform to the IEEE 802.11 standard promulgated by the Institute of Electrical and Electronic Engineers. The interface unit 16B may further comprise an IP (Internet Protocol) address 30, which may facilitate the transmission of wireless messages 34 via the Wi-Fi interface 28 to and from any other IP-enabled device via TCP/IP protocol. Other communication protocols may be used as well.

In one embodiment, the Wi-Fi interface 28 may be wirelessly coupled to an external device with access to the internet (e.g., a wireless router or wireless access point). This external device may be connected to the internet via a wired or a wireless means. Accordingly, the interface unit 16B may be capable of transmitting wireless messages 34 to and from a smartphone (e.g., an iPhone®, Android®, or Windows® phone) which also has access to the internet (e.g., via the smartphone's cellular network). The interface unit 16B may send a message 34 to the smartphone, for example, when the measured atmospheric pressure has met the one or more criteria. In this scenario, the user of the smartphone may be miles away from the atmospheric pressure sensor and still receive messages from the atmospheric pressure sensor. The wireless message 34 may comprise a text message which may be transmitted to a smartphone using SMS (Short Message Service), email, or any other suitable text messaging service. In addition, the text message may have embedded graphics and/or video.

Turning to FIG. 3C, the interface unit 16C may also comprise a Bluetooth interface 36. The Bluetooth interface 36 may be capable of wirelessly sending and/or receiving wireless messages 40 via an antenna 38. In one embodiment, the Bluetooth interface 36 may conform to the Bluetooth 4.0 Specification promulgated by the Bluetooth Special Interest Group (www.bluetooth.org). The processing unit may be electrically coupled to the interface unit 16C such that the processing unit is operable to send and receive wireless messages 40 via the Bluetooth interface 36.

The Bluetooth interface 36 may be operable to interface to a receiving device which also conforms to the same Bluetooth 4.0 Specification. Such a receiving device may include a smartphone, a tablet computer, or a personal computer. The current Bluetooth specification only permits the wireless messages 40 to be reliably transmitted at relatively short distances, about 150 feet or less; that is, the receiving device should be within about 150 feet of the atmospheric pressure sensor for reliable transmission of the message. Thus, this type of interface may work well when the atmospheric pressure sensor is installed on, for example, a sailboat, and the user of the receiving device is always on or around the boat.

The Bluetooth interface 36 may also work well when the atmospheric pressure sensor is powered by a battery, a solar cell, or other low energy device. The Bluetooth 4.0 Specification permits an operating mode, called Bluetooth Low Energy, which is designed to use very little energy. As such, the atmospheric pressure sensor may transmit information (i.e., in a Bluetooth LE advertising packet) to the receiving device at a relatively long communication rate of, for example, once per minute. This information may include the measured atmospheric pressure, text messages, the battery level, and so forth. Such a communication rate may be long enough to conserve battery life while still providing the user of the receiving device relatively up-to-date information about the atmospheric pressure. In one embodiment, the wireless messages 40 may conform to the Bluetooth Low Energy protocol.

FIG. 3D depicts yet another embodiment of the interface unit 16D which comprises a cellular network interface 42. The processing unit may be electrically coupled to the cellular network interface 42 such that the processing unit is capable of wirelessly sending and/or receiving wireless messages via the cellular network interface 42. The cellular network interface 42 may comprise an antenna 44 in order to facilitate the transmission and/or reception of wireless messages 46. The cellular network interface 42 may conform to the 3G, 4G, or any other suitable cellular network standard. In one embodiment, the cellular network interface 42 may conform to the 4G cellular network standard.

The wireless messages 46 may be transmitted to or received from a cellular tower 48 comprising a tower antenna 50. A wireless message 46 transmitted to a receiving device (not shown) may first be transmitted from the cellular network interface 42 (via the antenna 44) to the cellular tower 48 (via the tower antenna 50). The wireless message 46 may then be transmitted to the receiving device via the cellular tower 48. In another scenario, the wireless message 46 may first be transmitted to the cellular tower 48, then transmitted to a second cellular tower (not shown) which may be proximate to the receiving device, and finally transmitted from the second cellular tower to the receiving device. As such, the atmospheric pressure sensor may transmit a wireless message 46 directly to a receiving device via one or more cellular towers. The wireless message 46 may comprise a voice message, a text message (e.g., via SMS messaging service), an email, or any other suitable message.

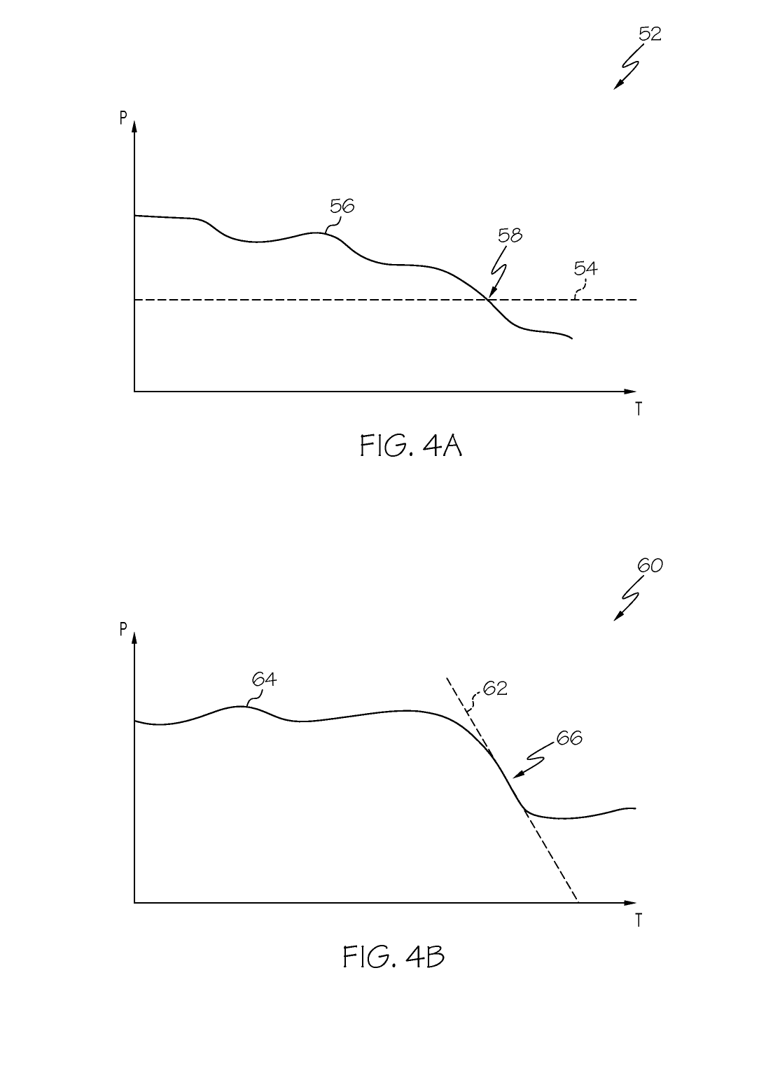

FIGS. 4A-B show examples of criteria which may be used by the processing unit in order to determine whether the processing units generates and sends a message to a receiving device via the interface unit. In FIG. 4A, the criterion 52 comprises whether or not the measured atmospheric pressure 56 falls below a pressure setpoint 54. The vertical axis is measured atmospheric pressure, P, while the horizontal axis is time, T. The measured atmospheric pressure increases when moving from the bottom to the top of the pressure axis, while time moves forward when moving from left to right along the time axis. At first, the measured atmospheric pressure 56 is above the pressure setpoint 54, so no message is sent by the processing unit. At time 58, the measured atmospheric pressure 56 falls below the pressure setpoint 54 (i.e., the criterion is considered to have been “met”), and the processing unit may generate and send a message accordingly. It is to be understood that the criterion 52 may also comprise whether the measured atmospheric pressure 56 rises above the pressure setpoint 54. It is also to be understood that the criteria may include one or more pressure setpoints. The pressure setpoints may be fixed, or they may be adaptive such that they are continuously calculated using a formula based on the measured atmospheric pressure.

In FIG. 4B, the criterion 60 comprises whether or not the change in measured atmospheric pressure 64 with respect to time exceeds a pressure rate setpoint 62. The vertical and horizontal axes have the same definition as in FIG. 4A. At first, the change in measured atmospheric pressure 64 with respect to time does not exceed the pressure rate setpoint 62. At time 66, the change in measured atmospheric pressure 64 exceeds the pressure rate setpoint 62 (i.e., the criterion is considered to have been “met”), and the processing unit may generate and send a message accordingly. The pressure rate setpoint 62 may be signed such that it may be a positive or negative number. For positive pressure rate setpoints, the pressure rate setpoint may be exceeded when the positive change in measured atmospheric pressure with respect to time is larger than the pressure rate setpoint. Likewise, for negative pressure rate setpoints (as shown in FIG. 4B), the pressure rate setpoint 62 may be exceeded when the negative change in measured atmospheric pressure 64 with respect to time is larger (i.e., the slope is larger) than the pressure rate setpoint 62. It is to be understood that the criteria may include one or more pressure rate setpoints, which may be combined with one or more pressure setpoints. The pressure rate setpoints may be fixed, or they may be adaptive such that they are continuously calculated using a formula based on the measured atmospheric pressure.

The two or more criteria may further comprise the logic on how to combine each individual criterion. The logic may include “AND,” “OR,” “EXCLUSIVE OR,” any other suitable logic, and/or combinations thereof. Such logic may instruct the processing unit on how to combine two or more criteria in order to determine when the criteria are considered to have been “met” and to send a message to the receiving device. For the following examples, assume there are three criteria, called Criterion #1 (C1), Criterion #2 (C2), and Criterion #3 (C3). In the first example, the criteria may only be considered to have been “met” when all three are individually met (i.e., an “AND” logic). This may be written as “C1 AND C2 AND C3.” In another example, the criteria may only be considered to have been “met” when any of the three are individually met (i.e., an “OR” logic). This may be written as “C1 OR C2 OR C3.” Other, more complicated logic may be used, as is known in the art. In yet another example, the logic may be “C1 AND (C2 OR C3).” It is to be understood that, for the purposes of this disclosure, “criteria” includes each individual criterion (e.g., whether the change in measured atmospheric pressure with respect to time exceeds a pressure rate setpoint) as well as the logical relationship between them.

The measured atmospheric pressure may be conditioned by analog and/or digital signal processing. Regarding analog signal processing, the atmospheric pressure sensing element may comprise one or more analog filters which may improve the accuracy of the measurement. For example, the atmospheric pressure sensing element may comprise a low-pass analog filter which may, as is known in the art, remove measurements whose frequency is higher than the filter cutoff frequency. Regarding digital signal processing, the atmospheric pressure sensing element and/or the processing unit may implement one or more digital filters in order to improve the accuracy and/or resolution of the measurement. For example, the processing unit may implement a digital FIR (Finite Impulse Response) and/or digital IIR (Infinite Impulse Response) filter in order to condition the measured atmospheric pressure. The digital filter and the measurement update rate may be selected so that the measured atmospheric pressure is relatively accurate and reliable such that any conditions that could lead to false or incorrect measurements are filtered out.

The rate of change of the measured atmospheric pressure may be determined by numerous methods. In one embodiment, the rate of change may be determined by calculating the change in measured atmospheric pressure from the previous sample to the current sample and dividing by the corresponding time interval. For the purposes of this disclosure, this is defined as the “sample-to-sample rate of change.” In another embodiment, the rate of change may be determined by taking the average of a number, “N,” of the previous sample-to-sample rates of change. For example, the rate of change of the measured atmospheric pressure may be calculated by averaging 10 samples (i.e., N=10) of the previous sample-to-sample rates of change. As discussed previously, the update rate (i.e., the rate at which the atmospheric pressure is measured) may comprise any suitable rate such as, for example, once every 10 seconds (0.1 Hz), once every 30 seconds ( 1/30 Hz), or once every minute ( 1/60 Hz) such that the sample-to-sample rate of change is based on this update rate.

In one embodiment, the criterion may comprise whether the measured atmospheric pressure exceeds a pressure rate setpoint of approximately −0.025 inHg per hour. When the change in measured atmospheric pressure with respect to time exceeds this rate, a storm may be approaching. When the measured atmospheric pressure meets this criterion, the processing unit may transmit a message to a receiving device indicating that the criterion has been met and that inclement weather may be approaching. The user of the receiving device may view the message and decide to check with other sources (e.g., the local weather report or a real-time radar map) in order to confirm that the weather may be about to get worse. It may also be possible that the measured atmospheric pressure has met the criterion for some other reason, and that inclement weather is not approaching. Nevertheless, the message transmitted by the atmospheric pressure sensor may give the user of the receiving device sufficient notice to check the weather forecast and to take any precautions, if necessary.

The one or more criteria may be stored in the processing unit as discussed above and may be either fixed or adjustable. If the one or more criteria are fixed, they may be embedded in the program which is executed by the processing unit. If the one or more criteria are adjustable, they may be adjusted by one or more mechanisms. For example, the one or more criteria may be adjusted by the operation of the program executed by the processing unit. These adjustments may be based on the current and/or past atmospheric pressure measurements. Alternatively, adjustments of the one or more criteria may be made by a person or a device which is external to the atmospheric pressure sensor. In this case, the one or more criteria may be delivered to the atmospheric pressure sensor via the interface unit. For example, a user of the receiving device may adjust the one or more criteria by making the adjustments on the receiving device and transmitting the adjusted one or more criteria to the atmospheric pressure sensor via the interface unit. The adjusted one or more criteria may be delivered via Ethernet, Wi-Fi, Bluetooth, a cellular network, or any other suitable method.

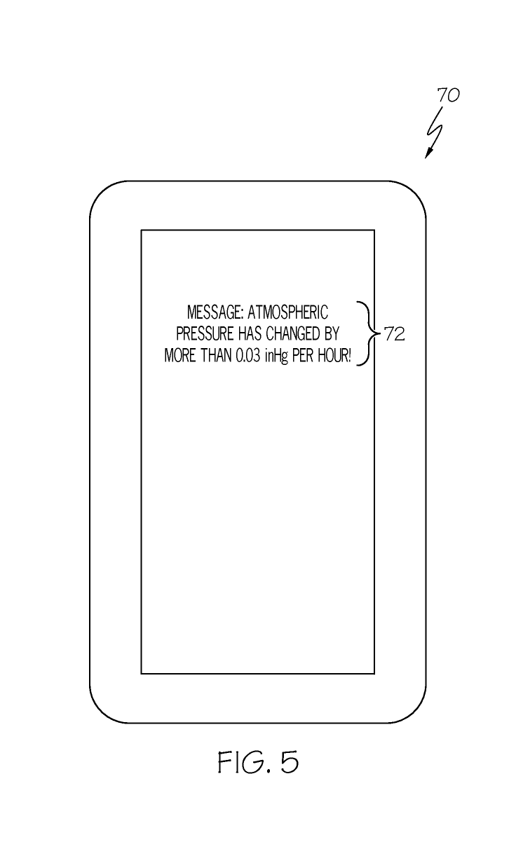

FIG. 5 shows one example of a device capable of receiving the message transmitted by the interface unit. In this example, the receiving device comprises a smartphone 70, such as an iPhone®, Android® phone, or Windows® phone. The smartphone 70 may have a display which is capable of showing the message 72 transmitted by the interface unit. In this instance, the message may indicate that the atmospheric pressure has fallen by more than −0.025 inHg per hour. As such, the user of the smartphone 70 may by duly notified that a storm may be approaching and that he or she should take appropriate action. Although the message shown in FIG. 5 is textual, it is to be understood that the message may also be graphical, audible, and/or tactile. For example, the message transmitted to the smartphone 70 may cause it to vibrate and produce an audible alarm.

The receiving device may also comprise other types of electronic devices, including those existing today and devices which may be developed in the future. For example, the receiving device may comprise a personal computer (e.g., a Windows® PC or an Apple® PC), a tablet computer (e.g., an iPad® or a Windows® Surface®, or a dedicated radio receiver. In one embodiment, the receiving device comprises an iPhone®, and the message comprises a text message transmitted using SMS text messaging service.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. An atmospheric pressure sensor comprising an atmospheric pressure sensing element, a processing unit, and an interface unit, wherein:
the atmospheric pressure sensing element is operable to measure the atmospheric pressure;
the processing unit is electrically coupled to the atmospheric pressure sensing element and is operable to read the measured atmospheric pressure from the atmospheric pressure sensing element;
the processing unit is operable to generate a message if the measured atmospheric pressure meets one or more criteria; and
the interface unit is electrically coupled to the processing unit and is operable to electrically receive the message from the processing unit and transmit the message to a receiving device.

2. The atmospheric pressure sensor of claim 1, wherein the one or more criteria comprise whether the measured atmospheric pressure rises above or falls below a pressure setpoint.

3. The atmospheric pressure sensor of claim 1, wherein the one or more criteria comprise whether the change in measured atmospheric pressure with respect to time exceeds a pressure rate setpoint.

4. The atmospheric pressure sensor of claim 3, wherein the pressure rate setpoint is approximately −0.025 inHg per hour.

5. The atmospheric pressure sensor of claim 1, wherein the processing unit is a microcontroller.

6. The atmospheric pressure sensor of claim 1, wherein the interface unit comprises an Ethernet interface operable to transmit the message via Ethernet to the receiving device.

7. The atmospheric pressure sensor of claim 1, wherein the interface unit comprises a wireless radio capable of wirelessly transmitting the message to the receiving device.

8. The atmospheric pressure sensor of claim 7, wherein the wireless radio comprises a Bluetooth radio.

9. The atmospheric pressure sensor of claim 1, wherein the interface unit comprises a cellular phone interface operable to interface to a cellular phone network.

10. The atmospheric pressure sensor of claim 9, wherein the receiving device is a cellular phone and the cellular phone interface is operable to transmit the message to the cellular phone via the cellular phone network.

11. The atmospheric pressure sensor of claim 1, wherein the message comprises an indication that the weather is about to change.

12. A method for transmitting a message from an atmospheric pressure sensor, wherein:
the atmospheric pressure sensor comprises an atmospheric pressure sensing element, a processing unit, and an interface unit,
the atmospheric pressure sensing element is electrically coupled to the processing unit; and
the interface unit is electrically coupled to the processing unit, and the method comprises:
measuring the atmospheric pressure by the atmospheric pressure sensing element;
reading the measured atmospheric pressure by the processing unit from the atmospheric pressure sensing element;
generating a message by the processing unit if the measured atmospheric pressure meets one or more criteria;
sending the message by the processing unit to the interface unit; and
transmitting the message by the interface unit to a receiving device.

13. The method of claim 12, wherein the one or more criteria comprise whether the measured atmospheric pressure rises above or falls below a pressure setpoint.

14. The method of claim 12, wherein the one or more criteria comprise whether the change in measured atmospheric pressure with respect to time exceeds a pressure rate setpoint.

15. The method of claim 14, wherein the pressure rate setpoint is approximately −0.025 inHg per hour.

16. The method of claim 12, wherein the interface unit comprises an Ethernet interface operable to transmit the message via Ethernet to the receiving device.

17. The method of claim 12, wherein the interface unit comprises a wireless radio capable of wirelessly transmitting the message to the receiving device.

18. The method of claim 17, wherein the wireless radio comprises a Bluetooth radio.

19. The method of claim 12, wherein the interface unit comprises a cellular phone interface operable to interface to a cellular phone network.

20. The method of claim 19, wherein the receiving device is a cellular phone and the cellular phone interface is operable to transmit the message to the cellular phone via the cellular phone network.
